(19) United States
(12) Patent Application Publication
(10) Pub. No.: US 2019/0278776 A1
(43) Pub. Date: Sep. 12, 2019

(54) SEARCH ENGINE SCORING AND RANKING

(71) Applicant: MUDPIE, SA DE CV, Roma (MX)

(72) Inventor: Mildred Villafañe, Lomas de Chapultepec (MX)

(21) Appl. No.: 16/294,241

(22) Filed: Mar. 6, 2019

Related U.S. Application Data
(63) Continuation-in-part of application No. 16/273,063, filed on Feb. 11, 2019.
(60) Provisional application No. 62/639,445, filed on Mar. 6, 2018.

(51) Int. Cl. G06F 16/2457; G06F 16/9535

(52) U.S. Cl. CPC G06F 16/24578; G06F 16/9535

(57) ABSTRACT

The technology described herein relates to a new and improved search engine platform that provides rankings and search results based on scores determined at least in part on user interactions with user created content referrals. Searches are thus performed on a user-defined data set, which provides more relevant information in fewer search results than is the case with other search engines. Ranked lists of content referrals having common topics are maintained according to scores associated with the content referrals or elements thereof. Search results may include individual content referrals or lists of content referrals.

### CROSS-REFERENCE TO RELATED APPLICATION

This application claims priority to U.S. Provisional Patent Application No. 62/639,445 filed on Mar. 6, 2018, which is entirely incorporated by reference herein. This application is a continuation-in-part of U.S. patent application Ser. No. 16/273,063, entitled “User Created Content Referral and Search,” filed on Feb. 11, 2019, which is entirely incorporated by reference herein. This application is also a continuation-in-part of U.S. patent application Ser. No. ______, entitled “Recommendation Acknowledgement and Tracking,” filed on Mar. 6, 2019, which is entirely incorporated by reference herein.

### BACKGROUND

Of the many promises realized from the development of the Internet and ubiquitous access to the World Wide Web, search applications and social network applications are arguably the two types of applications that have had the most profound effect on the world's population. When efficient search engines such as Google® and Yahoo! became available, Internet users were able to quickly locate virtually any kind of information. When social networks such as MySpace® and Facebook® grew to service over a billion users, their users had a new way to exchange information, either with people they already knew, with people who knew friends, with unknown people such as potential customers, etc. It is hard to imagine life today without these innovations.

Over time, the two concepts merged and information related to search began to be used in social media and vice versa. This confluence of the two technologies has led to what some see as an over-commercialization of their personal information collected from social media applications. It has also led to corrupted search results that make it more difficult for a user to find exactly what the user is searching for, due to advertisers and aggregators taking many of the top listings in a search result, and due to information from a user's social network being included—implicitly or explicitly—in a search without the user's knowledge.

This corruption of search results and lack of privacy and information have created a need for a more efficient way for users to search for reliable information about products, places, people, and the like.

### BRIEF DESCRIPTION OF THE DRAWINGS

The Detailed Description, below, makes reference to the accompanying figures. In the figures, the left-most digit(s) of a reference use of the same reference numbers in different figures indicates similar or identical items.

FIG. 1 is an illustration of an example content referral displayed on a smart phone.

FIG. 2 depicts an example content referral feed view that includes content referrals that have actuatable components that are functional in the feed view.

FIG. 3 is an illustration of a content referral user interface displaying a content referral and actuatable controls by which a user can assign attributes to the content referral.

FIG. 4 depicts an example list user interface that displays items included in a ranked list of items.

FIG. 5 is an illustration of an example search user interface that includes various search filters that may be implemented by a user.

FIG. 6 is an illustration of an example search results user interface.

FIG. 7 is an illustration of an example personal results user interface that displays information associated with personal interests of a user.

FIG. 8 is a depiction of a “Near Me” user interface 800 in accordance with the presently described techniques.

FIG. 9 depicts a representation of an example content referral database that may be utilized with the techniques described herein.

FIG. 10 depicts a representation of an example lists database that may be utilized with the techniques described herein.

FIG. 11 is a block diagram representing an example score database that may be utilized with the techniques described herein.

FIG. 12 depicts a representation of an example item score database that may be utilized with the techniques described herein.

FIG. 13 depicts a representation of an example item score database with values as may be utilized with the techniques described herein.

FIG. 14 is a block diagram representing an example electronic device on which one or more portions of the present inventions may be implemented.

FIG. 15 is a block diagram depicting an example server operational environment in accordance with the techniques described herein.

FIG. 16 is a flow diagram that depicts an example methodological implementation for updating a score associated with an element of a content referral.

FIG. 17 is a flow diagram that depicts an example methodological implementation for searching content referrals for use in the techniques presented herein.

FIG. 18 is an example compatibility user interface displaying top matches for search terms related to business partners.

### DETAILED DESCRIPTION

The technology described herein relates to a new and improved search engine platform that provides rankings and search results based on scores determined at least in part on user interactions with user created content referrals and related actions and events.

User creation of and user interactions with content referrals provide an accurate insight into users' interests, emotions, attitudes, and opinions. Attributing a score to each user interaction with content referrals provides a numerical value that can be used as a foundation to provide data to users searching for particular information about a subject, be it a person, a place, a thing, a topic of interest, etc. Such data provided to users by way of a search engine that searches information contained in one or more databases of content referrals and related information is more relevant than results provided by other search engines, in that the data set on which searches are performed have directly relatable information on the topics that users want to know more about. The techniques described herein provide a more efficient search engine, in that the techniques operate to save users' time as well as computer and network resources in performing searches, since fewer searches are required to find relevant information and since the searched data set is smaller than a data set consisting of virtually everything on the Internet. Information from the content referrals and data related to the content referrals can be used to create databases of information. Because the contents of the searchable database are informed by identifiable users, a search of the database provides results that are more relevant to a user performing the search, and more reliable due to the searched information coming from a known source and/or trusted population of users. In addition, a user may limit a searched data set to one consisting of input from a single person (such as friend or a favorite celebrity) or a group of persons (typically a group of persons having at least one common characteristic, such as people in a certain geographic area, people of a certain age group, people the user follows, etc.), thus providing results that are more relevant to the searching user than the user can get with current search engines.

A feature of the presently described techniques is the use of ranked lists in user preferences and searches. Ranked lists can be personal or global. Personal lists are lists of items by category that relate to a particular person or entity, such as a merchant. For example, a personal top ten list might be “Tiffany's® Best Places to Propose in New York City,” or a celebrity may maintain a list of favorite cars. Such lists can be shared, for example, with followers, or they may be made public. Global lists are ranked lists that are compiled across a number of persons or entities. For example, a list of “Best Delicatessens in Chicago” may be compiled from multiple sources, such as personal lists or external sources of information, such as “Best Of” lists published by magazines, ratings, reviews, etc. Different types of lists may be used with the techniques described herein. Such lists include, but are not limited to, collaborative lists, poll lists, birthday wish lists, etc. Collaborative lists are a variant of personal lists where a creator can invite one or more other users to collaborate in the creation of a list. This means the other users can add and delete content referrals. A poll list is a list in which users can vote for an element they want to include in the list. A birthday wish list or gift registry list is a personal list in which a user adds elements representing products the user would like for the user's birthday, wedding, or other occasion. The user's followers can access a birthday wish list and acquire one or more of the products in the list, and those products will be sent to the user.

Lists may also be requested by a user. For example, if the “Tiffany's® Best Places to Propose in New York City” did not exist, a user may send a request to Tiffany's® and ask that they create such a list. To encourage participation, interactions associated with a list request may receive score points. In this example, a score associated with Tiffanys® may receive a score increase, scores associated with list items may all get a score increase, etc. In addition, an entity (person or business) that receives a list request and fulfills the request may also be designated an “expert” related to the category. As such, an “expert” designation would indicate that status to other users. Being designated an expert may carry a score increase, and an expert's participation in their category may receive bonus points for their expertise.

Score adjustments may be assigned to various aspects of the different types of lists. With a collaborative list, each user that collaborates by adding a content referral to the list may receive a score adjustment of a score pertaining to the user. An element of a content referral contributed by a user to a collaborative list may be given a score adjustment to a score pertaining to the element. With respect to a poll list, a content referral added as an option in the poll may also receive a score adjustment when it is added. Score adjustments may also be made based on votes received by an item in the poll list, as may voters who participate in the poll.

The scoring system disclosed herein provides a basis for ranking lists. The scoring system is based, at least in part, on user interactions with content referrals, lists, searches, etc. Such interactions taken by users can be used to augment or diminish a score of a particular element, such as a subject of a content referral, a category of a content referral, the content referral itself, etc. Such user interactions (also referred to herein as internal factors) may include, but are not limited to: a rating on a scale of ratings; a like; a recycle; a positive or negative comment; a thanks; a share; an action taken by a user from a content referral or in relation to a content referral; an add to a list; a click; a request a list; a create a list; a request list update; a list update; visit a profile; votes; content funnels; a ranking; search; positive attributes (e.g., funny, aesthetic, innovative, talented, etc.); negative attributes (e.g., misleading, deceptive, fake, etc.); and the like.

In addition to such internal factors, scoring may also be based, at least in part, on external factors, which may include, but are not limited to: user transactions (outside of the system); analytics from a different platform; a different platform's metadata (such as ratings, scorings, rankings, and the like); equities pricing and movements; public information related to products, services, real estate transactions, auctions; search results; published votes; content funnels, automatic creation of a content referral triggered by a user transaction; and the like.

Scoring may also be associated with actions taken by users relative to a content referral. Actions can be associated with content referrals and/or an element of a content referral. For example, if an element of a content referral is a subject that is a consumer product, an action may be available to navigate to a site to purchase that particular product, or purchase directly from the content referral. Or, for example, if a user searches for restaurants in a particular neighborhood or specializing in a particular type of food, an action may be available whereby the user can make a reservation at a restaurant returned in a search result, order delivery from the restaurant, buy tickets for a show, etc. Other actions may also be included. Score adjustments may be assigned to any such action, so that when a user performs an action, scores associated with various persons or entities are adjusted to reflect that the action has been taken. For example, if a user purchases a product by taking an action from a content referral user interface, a score associated with the user may be adjusted, a score associated with the product may be adjusted, a score associated with a product seller may be adjusted, etc.

Generally, users begin with a basic content entry user interface (referred to herein as a “content referral”) to enter media content, a title for the content referral, one or more categories with which the content referral is associated, and one or more ratings associated with a thing, person, etc. By associating multiple categories with a content referral, a user can increase the chances that the content referral will be identified in a search. It is noted that one or more of the items listed above (media content, title, categories, rating) may be omitted from a content referral creation process. Different implementations may require more or fewer of these and similar items. Creating a content referral, and interactions taken therewith, affect scores of people and things associated with the content referral as well as the content referral itself. For example, the person who creates the content referral may get scoring points for doing so, and a subject of the content referral may also get points, etc. More details on scoring as related to content referral creation are provided below.

When a content referral has been composed, the content referral can be posted by a user to a user feed, which is viewable by user connections, an identified group of people, the general public, etc. Other users may comment on a content referral in the author's feed and can use content of the content referral to create their own referral with at least some elements of the content referral. These and other interactions may receive points in the scoring system described herein, as viewer interaction with a content referral provide a measure of its favorability or popularity. When a content referral is created, a record corresponding to the content referral is created in one or more databases to preserve the entry. A score associated with the content referral is included in the record. As contemplated herein, a content referral record is created in a searchable content referral database. Other types of records may be created in other types of databases depending on the implementation. In the examples described herein, a database of lists is maintained, and certain elements of a content referral—such as a description name and category—are stored therein.

Search results from searches performed within the systems described herein are based, in some respects, on scores associated with searchable items and provide more reliable results than current search applications. For one, search aggregators can be prevented from manipulating the system, thus allowing directly relevant search results to be ranked at the top of a results list. Additionally, a user can search a subset of the general population that is deemed by the user to have a more relevant understanding of what the user is searching for, thus allowing the user to reach a reliable result more quickly (i.e. with fewer search operations). For example, a user may wish to limit a search for a local restaurant to people who actually live in a neighborhood, who might frequent local restaurants more than people who live outside the neighborhood. Or a user may wish to look at a top ten list for a particular celebrity the user follows, so as to get a recommendation from the celebrity.

Another feature described herein is a technique that allows a seller of a product to determine a source of a buyer's motivation to purchase the product or service, such as a person that referred the buyer to the product or service (or a seller of the product or service). A user can use a “thanks” feature to express appreciation to a person on whose recommendation they relied on to purchase or explore interest in a product or service. With regard to scoring, when a subsequent user gives thanks to an original user, the original user may get points assigned for receiving thanks. In one or more implementation, the subsequent user may also get points—albeit a reduced amount—for providing the thanks, so as to encourage users to participate in this feature and to execute an action (such as making a purchase, for example) from the thanked content referral.

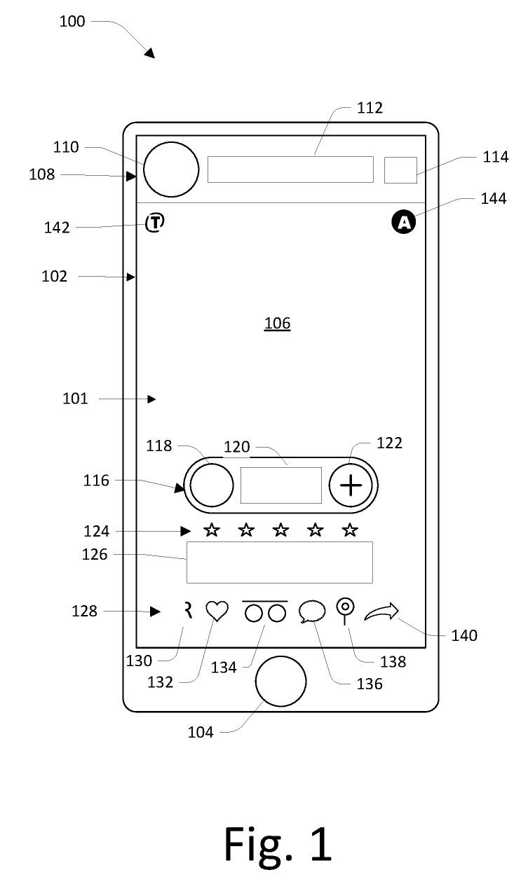

Other features and technological advancements of the systems and methods disclosed herein will be apparent from the present description and corresponding FIGS. 1-15.

### Content Referral User Interface

FIG. 1 is an illustration of a smart phone 100 displaying an example content referral 101. The smart phone 100 includes a display 102 and a home button 104 similar to those commonly found in contemporary smart phones. The example content referral 101 includes an image field 106 on the display 102 where an image related to a subject of a content referral 101 is displayed. It is noted that a content referral may have more than one subject@category. In such a case, images of all the subject@category may appear in the image field 106. The example content referral 101 also includes a title bar 108 that displays certain information related to the content slide, such as a personal icon 110, a user name 112, and a score 114. The personal icon 110 may consist of a photograph of a user associated with the content slide, an avatar, a logo, or the like. The user name 112 may consist of a user's real name or alias, or an entity identifier, such as a company name, team name, etc. The score 114 (described in greater detail below) is based on interactions with the example content referral 101 and may be used to rank the example content referral 101 against one or more other content referrals.

Another component of the example content referral 101 is a descriptor bar 116, which can contain various elements related to a subject of the content referral shown in the example content referral 101. In the present example, the descriptor bar 116 includes an image icon 118, a description field 120, and an addition icon 122. Although the descriptor bar 116 is shown in the present example as having a limited number of components, one or more alternative implementations may utilize more or fewer components than those shown and described herein. The image icon 118 is a visual representation that may be related to a subject matter of a content referral being created using the example content referral 101, such as a smaller version of a photo shown in the image field 106, text related to content shown in the example content referral 101, or the like. The image icon 118 may also be unrelated to the subject matter of the content referral, such as in a case where the subject matter is an audio recording and the image icon 118 may simply be an image that indicates the presence of an audio recording. The description field 120 is configured to display a description of content shown in the example content referral 101. Such a description may vary by implementation, and at least one variation implements a description in the format of “subject@category,” wherein “subject” describes a subject of the content referral 101 (such as a product, place, person, etc.) and “category” is a user-selected category of subjects (such as jeans, restaurants, Lady Gaga, etc.). A character may be used to separate the subject and category denotations, such as the “@” character used in examples used herein. It is noted that a content referral may have more than one element. For example, a content referral may focus on “Lady Gaga Dresses.” In such a case, “Lady Gaga@singers” may be an element, and “dress@gucci” may be another element. The techniques described herein operate in the same manner whether a content referral has a single or multiple subject@category. Finally, the addition icon 122 of the descriptor bar 116 is an actuatable control that is configured to add a content referral created from the example content referral 101 to one or more lists. This feature and the concepts and roles of lists are described in greater detail below.

The example content referral 101 also includes a rating input mechanism 124, a review dialog box 126, and multiple widget icons 128. The rating input mechanism 124 can be any such function that is capable of allowing a user to input a score from a range of scores, said score indicating a user's favorability rating, or sentiment, toward the subject matter of a content referral created by way of the example content referral 101. In the present example, a user may assign a rating of from one star to five stars. Alternative implementations may include a different variation of a rating input function, such as an assigning of a numerical value within a range such as one to ten, thumbs up and down, emoticons, etc. The review dialog box 126 is configured to accept input from a user that is not limited to any particular range of acceptable inputs, such as a text entry containing ASCII characters.

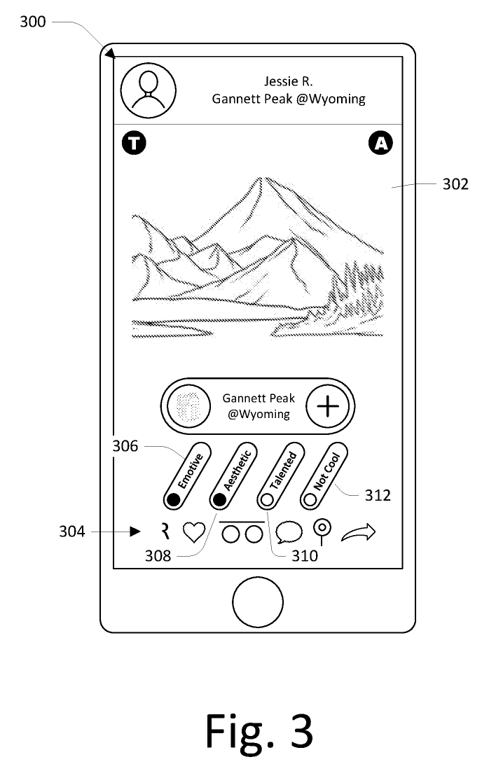

The widget icons 128 can be any number of icons configured to perform virtually any electronically-based task. In the present example, the widget icons 128 include an attributes icon 130, a like icon 132, a recycle icon 134, a comment icon 136, a thanks icon 138, and a forward icon 140. The attributes icon 130 displays a set of attributes that describe positive and/or negative characteristics of a content referral. For example, if a viewing user thinks that a content referral is aesthetically pleasing, the user may use the attributes icon 130 to express that feeling. The user may express other subjective attributes of the content referral, such as whether the user thinks the content referral is funny, innovative, misleading, deceptive, fake news, etc. The user may also use the attributes icon 130 to express the user's feeling to denote that the content referral is talented, etc. Through use of the attributes icon 130, users can evaluate a creator's content. User entries by way of the attributes icon 130 may increase a score associated with a subject of a content referral if the assigned attribute is positive, or they may decrease such a score, if the assigned attribute is negative score. Distinguishable from the attributes icon 130 is the like icon 132. The like icon 132 is similar to like icons found in other platforms. When a user actuates the like icon 132, it is a way for the user to indicate that the user likes something in particular with the content referral displayed with the like icon 132. However, the like icon function is a more ambiguous appreciation for the content referral as a whole, as it cannot be determined what it is about the content referral that the user likes—the content referral as a whole, the user who created the content referral, an image included in the content referral, etc. As regards to scoring, the specific appreciations indicated by use of the attributes icon 130 may receive more weight than the general appreciations shown by use of the like icon 132. Further details of assigning attributes and a user interface therefor is shown in and described in relation to FIG. 3, below.

The recycle icon 134 may be actuated by a user when the user wants to create a new content referral based on an existing content referral, i.e., the user “recycles” one or more components of the content referral. The comment icon 136 is actuated by a user when the user wants to enter a comment to be associated with a content referral. The thanks icon 138 may be actuated by a user when the user wants to identify the source of a referral that will lead to or has led to an action on a product, place, business, etc. The forward icon 140, when actuated by a user, forwards the content referral to another user as a link or code of the native platform to one or more external platforms such as social media platforms, messaging platforms, email platforms, etc. This may also be used to enable people to purchase a product or service or perform a different action related to the content referral from an external platform. The function of the forward icon 140 enables capitalization of sharing of content from the native platform while continuing to track and generate data. It is noted that a scoring system used to score and rank content referrals may associate a score with any action taken with the aforementioned icons. For example, a score for a restaurant may be increased when a user actuates the like icon 132 in a content referral interface having the restaurant as its subject.

One or more of the widget icons 128 may be actuatable from the example content referral 101, but one or more of the widget icons 128 may be inoperable, at least in the present example content referral 101. In the present example, for instance, the comment icon 136 may not be operable with the example content referral 101, but may be present to show a complete view of a content referral that is created by way of the example content referral 101. This way, a user can more completely see what a content referral will look like as the user is creating it using the example content referral 101. In at least one alternative implementation, action icons that are not actuatable in a particular user interface are not displayed in that particular user interface.

The example content referral 101 also includes a top ten icon 142 and an action icon 144. A user may actuate the top ten icon 142 to view all categories that a content referral creator assigns to a content referral. For example, if a subject of the content referral is “Gannett Peak,” then additional categories added by the creator may include “Wyoming,” “Mountains,” “Hiking,” etc. The user may select one of the displayed categories to view a list associated with each category. In at least one implementation, a user can add an additional category and/or a list (personal top ten, global top ten, ranked list, favorites, etc.) by way of the top ten icon 142. The action icon 144 is actuatable by a user to select an action to associate with the content referral created by way of the example content referral 101. The function of both the top ten icon 142 and the action icon 144 are described in greater detail below, with respect to the subsequent figures.

### Content Referral Feed

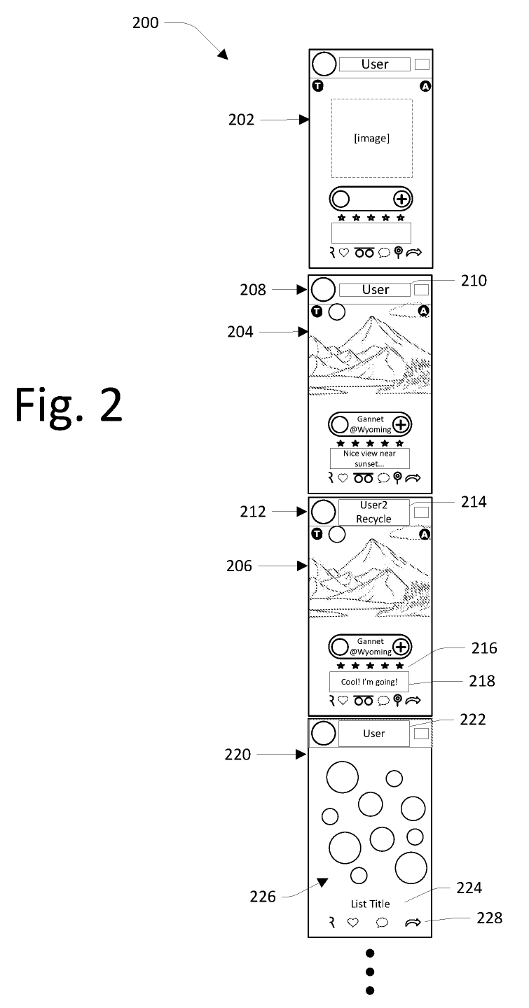

FIG. 2 depicts an example content referral feed 200 as it might be displayed on an electronic device, such as a smart phone or personal computer. The example content referral feed 200 includes a generic content referral template 202, a user-created content referral 204, and a re-created (i.e., re-posted) content referral 206. It is noted that although only three content referrals are shown in FIG. 2, more content referrals may also make up a portion of the example content referral feed 200. As indicated in FIG. 2, other content referrals (not shown) may be exposed by scrolling the example content referral feed 200 up or down, through swiping gestures, arrow buttons, etc.

The user-created content referral 204 depicts the look of a content referral as previously described. It is noted that at least some of the features of the content referral 101 shown in and described with respect to FIG. 1 are actuatable from the example content referral feed 200. This means that a user who is viewing the feed may act directly on items included in a content referral (such as taken an action associated therewith) instead of having to open an individual content referral before making a selection.

The user-created content referral 204 identifies a user that created the content referral in the title bar 208 of the content referral 204. In the present example, a user name 210 is shown as the word “User” (used here as a generic substitute for an actual user name that identifies a user (see, e.g., user name 112, FIG. 1) to identify a user who created the content referral 204. In contrast, a title bar 212 that is a part of the recycled content referral 206 includes a user name 214 “User2 Recycle” to clarify that the recycled content referral 206 was not created by the person associated with the user name 210 in the title bar 208, but has been recreated by a user other than the user that created the recycled content referral 206. In operation, “User2 Recycle” would be replaced with a typical user name. The recycled content referral 206 is similar to the user-created content referral 204 on which it is based, except that it has a different user name 214 and it may have a different rating 216 and/or a different review 218. This is because a second user may recycle a content referral from a first user and enter a rating and review unique to the second user.

The example content referral feed 200 also includes a personal list 220 created by a user who is identified by a user name 222. A list title 224 is shown together with list items 226. In the present example, the list items are each represented by a circle, which may have an image or text contained therein. However, other implementations may display list items in other ways. The personal list 220 also includes interactive icons 228 similar to icons shown in and described with respect to FIG. 1. A user viewing the feed 200 may actuate an interactive icon 228 and directly access the functionality without first having to take an intermediary step of opening the personal list 220.

Scores can be affected by actions taken by way of a content referral in a feed. When a viewer of a feed interacts with a content referral in the feed, the content referral and one or more aspects thereof may receive an adjustment to a score associated therewith. Such scoring adjustments may be positive (an increase in score) or negative (a decrease in score), depending on the interaction. Basically, any interaction with a content referral may receive scoring points that affect one or more scores, whether the content referral is being viewed individually or in a feed.

### Content Referral Attribute Assignment

FIG. 3 is an illustration of a content referral attributes user interface 300 displaying a content referral 302 through which a user can assign attributes to the content referral. The attributes user interface 300 is shown when a user selects the attributes icon 130 (FIG. 1). In addition to displaying most of the elements shown in the example content referral 101, the attributes user interface 300 includes a plurality of attributes controls 304, which may vary among different implementations. Scoring adjustments may be assigned to each attribute control 304 such that selection of one of the attribute controls 304 adds to or subtracts from scores associated with the content referral 302, the creator of the content referral 304, or an element associated with the content referral 304.

In the present example, the attributes controls 304 include an “emotive” control 306, an “aesthetic” control 308, a “talented” control 310, and a “Not Cool” control 312. The aesthetic controls 304 provide a way that a viewer of the content referral 302 can express their feelings about what is contained in the content referral 302. In this example, the “emotive” control 306 allows a user to express that elements of the content referral 302 express an emotion that strikes the user. Such a selection may add a positive scoring adjustment to the content referral 302, the creator of the content referral 302, or an element associated with the content referral 302. The “aesthetic” control 308 allows a user to indicate that they think the aesthetics of the content referral 302 are pleasing, and selection thereof may add a positive scoring adjustment to scores for the content referral 302, the creator, or an element of the content referral 302. The “talented” control 310 allows a user to indicate that they think the creator of the content referral 302 is talented. Such a selection may increase a score associated with the creator, and other people can inform an opinion about the creator's talent from that score. Selection of the “Not Cool” control 312 shows that a user is not pleased with the content of the content referral 302 for some reason. In such a case, a negative scoring adjustment may be made to scores associated with the content referral 302, its creator, or an element therein.

### Top Ten List

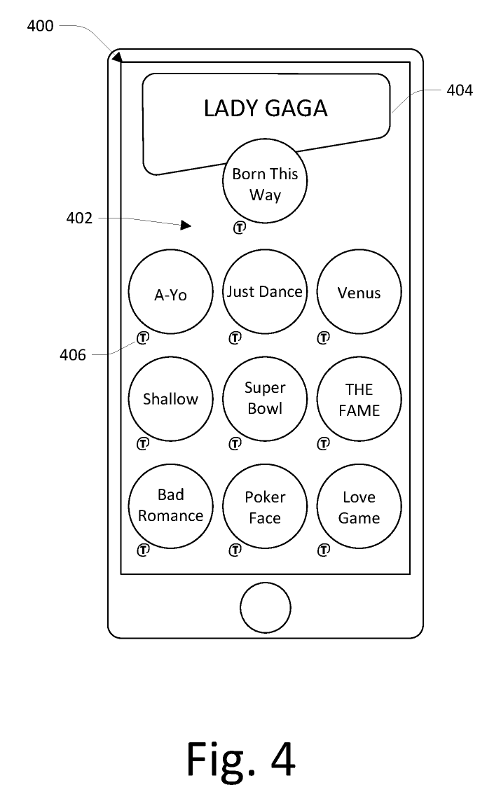

FIG. 4 depicts an example list 400 that displays list items 402 included in a ranked list. It is noted that although the example list user interface 400 is shown having ten items, a list may be composed of any number of items. The example list 400 is shown as an example of a list that may be returned as a search result, as described in greater detail below. The example list 400 also includes a title that is shown in a title block 404. The items in the example list 400 are shown in a ranked order, and the ranking is made according to scores associated with each item in the list 400. Individual list items attain scores from user interactions that are related to the list items 402. In this example, a category of the list is “Lady Gaga,” which is shown in the title block 404. The example list 400 is a global list that is drawn from personal lists made by multiple users. If a user wants to find the most popular Lady Gaga performances, she can search for Lady Gaga and find the example list 400. An actuatable action icon 406 is associated with each of the list items 402. When an action icon 406 is actuated, a menu of possible actions may be displayed, allowing a user to select one of the menu options. In the present example, actuation of one of the action icons 406 could, for example, provide a menu that allows a user to procure the performance identified in the list item 402, to go to a web site with information related to the identified performance, and so on. In at least one implementation, actuating an action icon 406 takes a user to buy, reserve, etc., directly with one or few clicks if the user has linked an outside account to the platform, or directly add to a wish list of another platform, or immediately takes a user to a site where the user can purchase the content identified in the action icon 406, etc., (i.e., there is no intermediate drop-down menu).

### Search User Interface

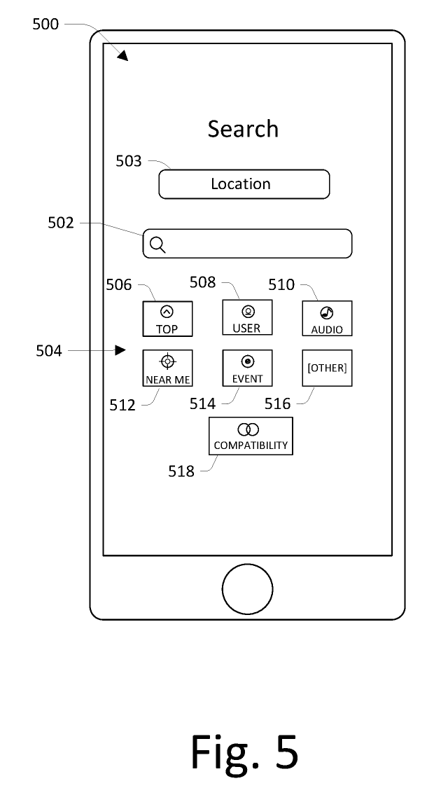

FIG. 5 is an illustration of an example search user interface 500 that may be used with the techniques described herein. The example search user interface 500 includes a search bar 502, a geolocation box 503, and multiple search filters 504 that may be implemented by a user to refine search results. The geolocation box 503 may be filled with a location by typing in the name of a location (city, neighborhood, etc.), by entering a zip code or an area code, by making a selection from a drop down menu, etc. When performing a search, a user will enter a search query in the search bar 502. The user may immediately enter the search using the search query, or the user may select one of the search filters 504 to execute the search with additional specifications. In the present example, the search filter 504 include a “Top” filter 506, a “User” filter 508, an “Audio” filter 510, a “Near Me” filter 512, and an “Event” filter 514. As shown, one of the search filters 504 includes an “Other” filter 516. This represents that any customized filter may be used with the present techniques. Another filter shown is a “Compatibility” filter 518, which is used to find other users who match certain desirable characteristics.

The “Top” filter 506 will cause a search to return results according to most popular results. In the present techniques, the most popular results are determined according to scores associated with elements of the search query. The “User” filter 508 will limit search results to user names that contain terms found in the search query. The “Audio” filter 510 will limit search results to audio content, thus eliminating articles, ads, and other “noise” from search results. The “Near Me” filter 512 will limit search results to a particular geographic area dependent on the user's location. The “Near Me” filter 512 is useful when searching for local restaurants, stores, etc. that the user wants to visit in person. The “Event” filter 514 limits search results to events that contain search query terms. The “Other” filter 516 can be any other type of filter, such as a geolocation filter (identifies a particular area in which to limit search results), a gender filter (e.g., only results from women), an age filter that limits results to people in a certain age range, a profession filter that limits results to lists related to certain professions, etc.

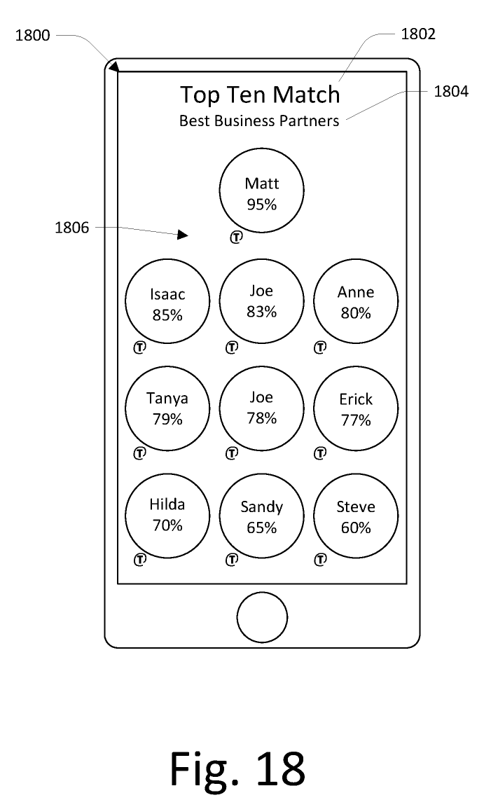

The “Compatibility” filter 518 can be used to find ideal relationships or matches with other users of the platform in matters of, for example, roommates, love, friendship, work, partnerships, travel, and the like. The “Compatibility” filter 518 may be used in conjunction with a geolocation filter (not shown) so as to be able to locate compatible relationships in a user's particular location. FIG. 18 is an example compatibility user interface 1800 displaying top matches for search terms related to business partners. The compatibility user interface 1800 includes a title 1802, a category 1804, an multiple list items 1806 returned in response to a search query. In this particular example, each list item 1806 identifies a user and a numeric value that indicates the degree to which search terms matched characteristics of the user shown in the list item. Other implementations may display different content in the list items, such as a photo of the matching user, etc. The position of each list item depends on the numeric value, or score. The score may be based on a combination of things. For example, the score may be based on content matches (wherein content referrals created by both users is similar), on demographic options (such as similarities in age, location, credentials, hobbies, professions, interests, etc., on astrological characteristics, and so forth.

All such filters further refine the search results to present the user with results that most closely match what the user is looking for. Further, because the lists returned as search results are ranked according to score, and because the position of returned results are determined according to score, the user can spend less time trying to find the best results.

Each of the search filters 504 is informed by scores associated with searched data to locate the best search results. When search results are presented, the result having the greatest score associated with it is displayed at the top of a page, and other results are displayed below it in order of their scores. As described in greater detail below, items in searched data sets attain scores from user interactions. Thus, an item's score depends on how many users shown interest in an item, either by procuring the item, writing about the item, or otherwise showing interest in the item. Using such a scoring methodology and the search filters 504 thus acts to limit search results to results that are likely to be most meaningful to the user.

### Search Results User Interface

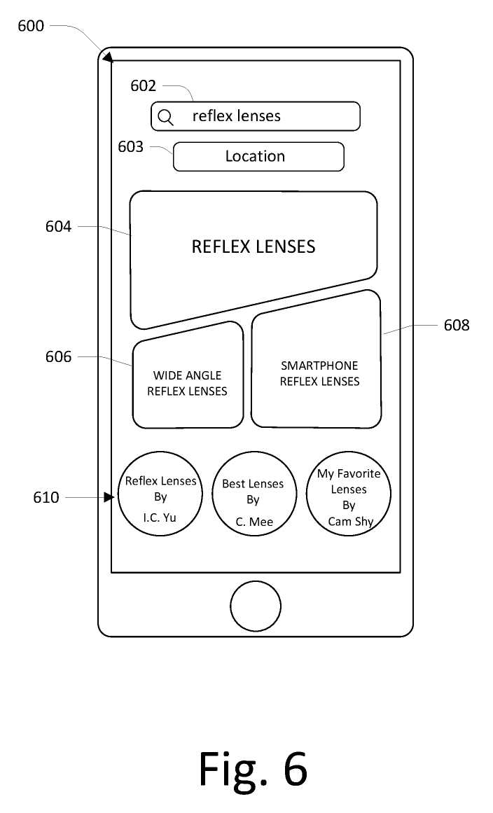

FIG. 6 is an illustration of an example search results user interface 600 in accordance with the present description. The search results user interface 600 is one way in which search results may be displayed to a user. The example search results user interface 600 includes a search bar 602 that displays terms contained in a search query, a geolocation box 603, a top result box 604, a first related result box 606, a second related result box 608, and personal lists 610 of the user that are related to the search query. As with other list functions, items contained in the search results user interface 600 are determined, at least in part, by scores associated with the individual items.

In the example shown in FIG. 6, the search query shown in the search bar 602 is “reflex lenses.” The geolocation box may be filled with a location by typing in the name of a location (city, neighborhood, street, country, etc.), by entering a zip code or an area code, by making a selection from a drop down menu, etc. Changing a value in the geolocation box 603 while viewing search results causes a new search to be performed and results related to the value in the geolocation box 603. The top result box 604 indicates that the top result of the search is a list having a title that exactly matches (if one exists) or closely matches the search query—“REFLEX LENSES.” The “REFLEX LENSES” list is a global list of content referrals that has been compiled from information and interactions associated with content referrals related to reflex lenses. In such a list, a top position will be held by a reflex lens that is most popular with users of the content referral system. “Most popular” is determined on the basis of which reflex lens content referral has the greatest score. Other items in the list will be included and ranked according to scores associated with the items.

The first related result box 606 displays the title of a list that has the second-highest score among lists that match the search query. Similarly, the second related result box 608 displays the title of a list that has the third-highest score among lists that match the search query. Like the most popular list, the lists shown in the first related result box 606 and the second related result box 608 are global lists, compiled from information obtained from many users. The personal lists 610 are lists that are created by identified users that relate to the search query.

### Personal Results User Interface

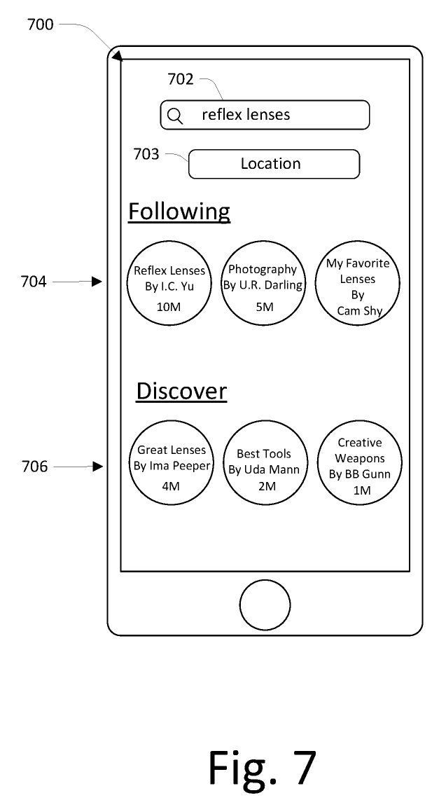

FIG. 7 is an illustration of an example personal results user interface 700 that displays information associated with personal interests of a user. The present example shows one particular implementation, but information shown in the personal results user interface 700 will vary between implementations. The example personal results user interface 700 includes a search bar 702, a geolocation box 703, followed lists 704, and related lists 706. The geolocation box may be filled with a location by typing in the name of a location (city, neighborhood, etc.), by entering a zip code or an area code, by making a selection from a drop down menu, etc. A search is then performed only on items that are in the designated location. Changing a value in the geolocation box 703 while viewing search results causes a new search to be performed and results related to the value in the geolocation box 703. The followed lists 704 include lists created by people that the user follows and that match a search query. The order in which the followed lists 704 are displayed according to a score associated with each of the followed lists 704. Such a score may be displayed in the user interface 700 or not, or a score exceeding a certain amount may be displayed while a score not exceeding the certain amount is not displayed. The related lists 706 include lists that have been created by people that the user does not follow, but that match the search query to a significant degree. Similar to with the followed lists 704, scores may be displayed with the related lists 706 to indicate a level of interest shown with respect to each list.

### Near Me User Interface

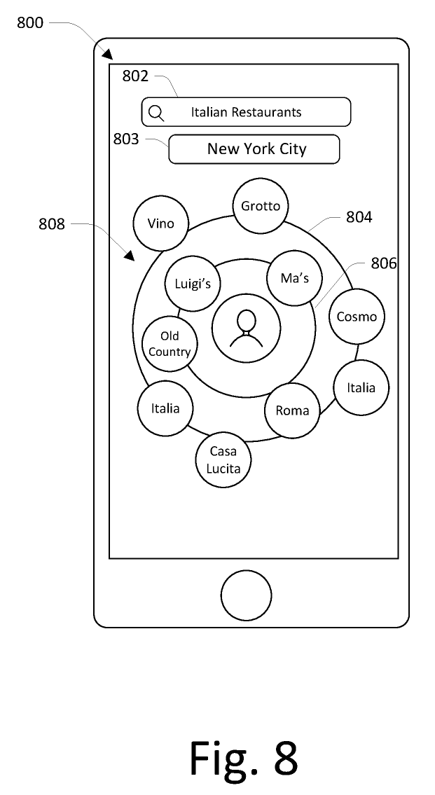

FIG. 8 is a depiction of a “Near Me” user interface 800 in accordance with the presently described techniques. The near me user interface 800 can be implemented as a way to display search results when the near me filter 512 (FIG. 5) is selected. The near me user interface 800 is useful in that a user can look at the user interface and quickly determine an approximate distance and direction to an item shown in the search results. The near me user interface 800 includes a search bar 802 that displays the search query used to provide the displayed results, and a geolocation box 803. When a search query is entered, a search is performed on candidate items located in a location identified in the geolocation box 803. The near me user interface 800 also includes a first ring 804 and a second ring 806 and multiple items 808 overlaid on the rings 804, 806. Each of the rings 804, 806 corresponds to a distance from a location of the user. The distances corresponding to the rings 804, 806 can be pre-set or they can be configured by the user.

The location of the items 808 on the rings 804, 806 indicates two things: a distance from the user (relative or absolute), and a general direction from the user. In the present example, the user has entered a search term of “Italian Restaurants” and has activated the “Near Me” filter 512. A list of top Italian restaurants near the user is identified by the search, and items in the list (i.e. restaurants) are displayed over the rings 804, 806 corresponding to a distance and direction of each item from the user. In one example, the first ring 804 indicates a distance of five miles and the second ring 806 indicates a distance of two miles. Activating a “walk” setting (not shown) may set the distances to correspond to walking distances, such as six blocks and twelve blocks. Items 808 overlaid centrally on the first ring 804 are about five miles from the user. Items 808 overlaid between the rings 804, 806 are located from between about five miles to ten miles from the user. Items 808 overlaid on the second ring 806 are located about ten miles from the user. In that example, a restaurant named “Casa Lucita” is located about eleven or twelve miles from the user, while a restaurant named “Luigi's” is located about five miles from the user. “Near Me” search results may include products, services (manicures, massages, etc.), specific food dishes (Spaghetti Bolognese, Chicken Masala, etc.) and the like.

### Content Referral Database

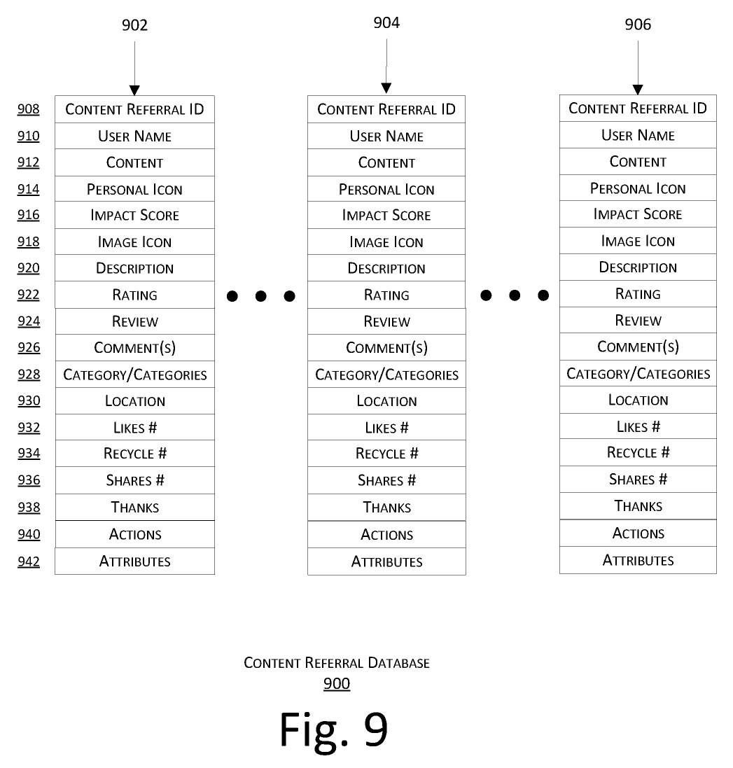

FIG. 9 depicts a representation of an example content referral database 900 that may be utilized with the techniques described herein. In the following discussion of the example content referral database 900, continuing reference is made to elements shown in and described with respect to previous figures. It is noted that the example content referral database 900 is only one particular implementation of a database that may be used to store information entered in content referrals. Those skilled in the art will recognize that similar databases or other storage, lookup, and recall techniques may be used with or in place of the example content referral database 900.

The example content referral database 900 includes multiple records, such as Record 902, Record 904, and Record 906. The records shown are for representative purposes only and the example content referral database 900, in practice, will contain a great number of records. Each record corresponds to a content referral created by a user. The example content referral database 900 stores some or all of the information entered by a user when the content referral is created. Each of the records 902-906 stores similar information.

As shown in FIG. 9, the records 902-906 include a content referral identifier 908, which is a unique identifier assigned to the content referral that corresponds to a record. The content referral identifier 908 is assigned by a system from information entered into the content referral, or created by the system in a content referral identification subsystem.

Each of the records 902-906 also includes a user name 910 (112, FIG. 1), content 912 (content captured by the corresponding content referral 100, which may include any type of content), a personal icon 914 (110, FIG. 1), a score 916 (114, FIG. 1), and an image icon 918 (118, FIG. 1). Each record 902-906 also stores a description 920 (from the description field 120, FIG. 1), a rating 922 (from the rating mechanism 124, FIG. 1), a review 924 (from the review dialog box 126 FIG. 1), and one or more comments 926 (captured from other users' comments on the corresponding content referral 100). The records 902-906 in the example content referral database 900 also include one or more categories 928 that have been assigned to the corresponding content referral 100 by the user, a location 930 of the subject of the corresponding content referral 100 (if applicable), a number of likes 932 that the corresponding content referral 100 receives from users other than the user that created the content referral 100, a number of recycles 934 that have used one or more elements of the corresponding content referral 100, and a number of shaers 936 of the corresponding content referral 100.

Each of the records 902-906 also includes entries for thanks 938 and action 940. The thanks 938 entry is used to store the name of one or more persons that have credited a user for a referral to a place, product, or thing that is the subject matter of a content referral associated with the record 902-906. Action 940 list one or more actions that a user who created the content referral has made available to a person who view the content referral (such as purchase a product, etc.). Each of the records 902-906 also includes an entry for attributes 942, which contains information related to the attributes icons 306-312 shown in FIG. 3.

Any information included in a content referral, whether it is entered by a user or captured from a source other than the user, may be stored in a record of the content referral database 900. To support a search function, the content referral database 900 is searchable on any element or combination of elements. Further characteristics of the example content referral database 900 are described in the context of certain functions, below.

### Lists Database

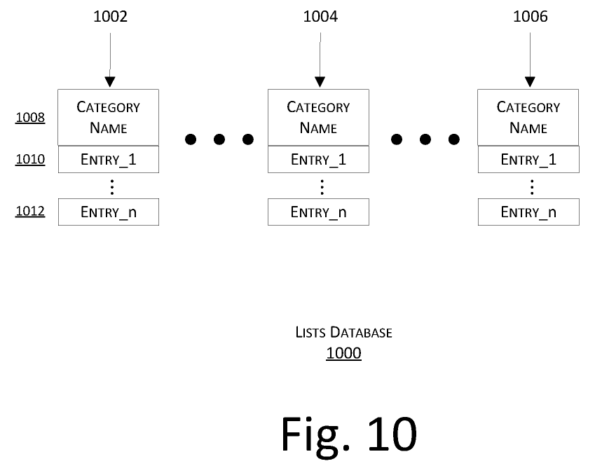

FIG. 10 depicts a representation of an example lists database 1000 that may be utilized with the techniques described herein. In the following discussion of the example lists database 1000, continuing reference is made to elements shown in and described with respect to previous figures. It is noted that the example lists database 1000 is only one particular implementation of a database that may be used to store list information related to content referrals. Those skilled in the art will recognize that similar databases or other storage, lookup, and recall techniques may be used with or in place of the example lists database 1000.

The example lists database 1000 stores multiple records, as illustrated by Record 1002, Record 1004, and Record 1006. Although only three records 1002-1006 are shown in the present example, many more records will be stored in the lists database 1000 in operation. Each record 1002-1006 of the example lists database 1000 includes a category name 1008 and one or more entries in a list associated with the category name 1008. The category name 1008 is taken from the description field 120 (FIG. 1) in a content referral. As previously notes, a description in the description field 120 is in a format of subject@category. Thus the category is a string of characters following the connecting symbol used in a particular implementation (in the present example, the connecting symbol is “@”). It is noted that in some circumstances, the subject may also represent a category.

Each record 1002-1006 also includes a first entry, Entry_1 1010, and other entries culminating with Entry_n 1012. A record 1002-1006 may only include a single entry (Entry_1 1010), but will typically include multiple entries. A maximum number of entries for each category may vary between implementations. For example, one or more implementations may utilize “Top Ten” lists and, therefore, limit a number of entries associated with a category to ten (10). In one or more alternate implementations, a maximum of forty (40) entries per category may be allowed for example. In other implementations, a number of entries may not be limited at all.

### Example Interaction Score Database

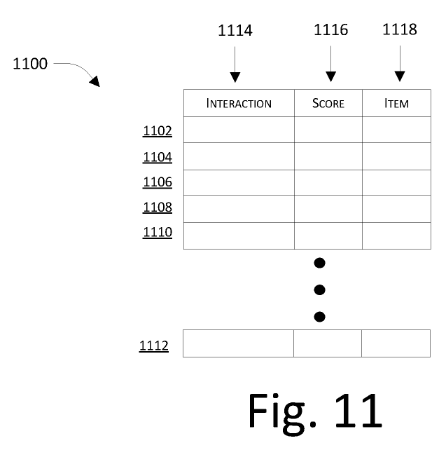

FIG. 11 depicts a representation of an example interaction score database that may be utilized with the techniques described herein. In the following discussion of the example interaction score database 1100, continuing reference is made to elements shown in and described with respect to previous figures. It is noted that the example interaction score database 1100 is only one particular implementation of a database that may be used to store information entered in content referrals. Those skilled in the art will recognize that similar databases or other storage, lookup, and recall techniques may be used with or in place of the example interaction score database 1100.

The example interaction score database 1100 includes multiple records, such as record 1102, record 1104, record 1106, record 1108, record 1110, and record 1112. Each of the records 1102-1112 includes three record fields: interaction field 1114, score field 1116, and item field 1118. The interaction field 1114 contains a value that corresponds to a unique interaction made by a user with respect to a content referral, a list, a feed, etc. Each user interaction that is deemed to be of some value to determining which content, products, creators, users, lists, etc. are most popular is assigned a value that is stored in an interaction field 1114 of a record 1102-1112. The score field 1116 stores a value that denotes a score that is associated with the interaction stored in the interaction field 1114 of the same record. The item field 1118 of a record 1102-1112 designates an entity that will receive the score in a corresponding score field 116 upon the detection of a user interaction identified in the interaction field 1114. Because a user interaction can initiate a scoring adjustment for several entities, or items, the interaction score database may include more than one record for a given user interaction. For example, if a user thanks a creator for a content referral, the creator may receive a score adjustment, and the content referral may also receive a score adjustment. In such a case, the interaction score database would have one record identifying a thanks interaction in the interaction field 1114, a score for receiving thanks in the score field 1116, and a value identifying the creator in the item field 1118. This would set up the system to update a score associated with the creator by the amount shown in the score field 1116. A different record would identify a thanks interaction in the interaction field 1114, a score for receiving thanks in the score field 1116, and a value identifying the content referral in the item field 1118. This would set up the system to update a score associated with the content referral by the amount shown in the score field 1116.

Any user interaction may receive score points in the techniques described herein. Interactions that favorably affect a user's score may be included to, in part, encourage users to participate more often, to obtain enhanced user status, to obtain rewards, etc. Table 1 shows a list of internal interactions that may have score points associated with them, and items (or entities) that may receive score points upon the occurrence of the interactions. The interactions and scored items shown in Table 1 are examples and are not intended to be an exhaustive list. It is noted that other implementations may feature different interactions and scored items.

TABLE 1

| INTERACTION | |
|---|---|
| (INTERNAL) | ENTITY RECEIVING SCORE POINTS |
| Creating a content referral | User, content referral, subject, category(ies) |
| Adding content to a content | User, content creator, promoter, distributor, |
| referral | subject, content referral |
| Adding secondary | User, content referral, secondary categories, |
| categories | derived categories |
| Adding a rating | User, subject, category(ies) |
| Adding an action | User, content referral, subject, producer, |
| | distributor, vendor |
| Linking an action to an end | Creator user, activator user, content referral, |
| item | subject, linked item creator, linked item |
| | seller |
| Recycle a content referral | Subject, content referral, user, original |
| | creator, category(ies) |
| Select action in a content | User, CR creator, subject of action, subject |
| referral | creator, category(ies), item, producer, |
| | distributor, vendor |
| Action conversion (i.e. a | Creator user, purchaser user, subject, seller, |
| purchase) | category(ies), producer, distributor, vendor |
| Charity donation | Creator user, charity, subject, category(ies), |
| | donator user, ambassador, NGO |
| Posting an event | CR, user, event, organizers, venue, user |
| | activation, artists/performers, subject, |
| | category(ies) |
| Add audio to play list | User, play list, producer, song, artist(s), |
| | subject, category(ies) |
| Add music to a content | User, artist, album, song, producer, record |
| referral | label, subject, category(ies) |
| Comments (neg, neutral, | User, CR, subject, category (depending on |
| pos) | the content of the comment) |
| Adding a CR to a list | CR creator, list, subject, category(ies), list |
| | creator |
| Collaborative list | All participating users, subject, category(ies) |
| Poll List | Subject, voters, category(ies) |
| Gift registry List | Subject, participating users, purchaser, |
| | category(ies) |
| Attributes (neg, neutral, | CR, CR creator, personal list, list creator |
| pos) | user |
| Sharing a list or CR | Receiving user when link is activated, CR, |
| | subject, category(ies) |
| Select Top Ten Icon and | List, list creator user, activation user, |
| List | subject, category selected |
| Like | CR, user, creator |
| Thanks (add to thanks list) | Subject, CR creator, category(ies) |
| Thanks (buy from thanks | Original CR creator, subject, item purchased, |
| list) | category(ies) |
| Search | Search terms, lists (possibly only if |
| | accessed), subject, category(ies) |
| Automated CR External | Transaction user, subject, categories, |
| Transaction | product/service, producer, distributor, |
| | vendor, intermediary, et al. |
| Comparisons and Averages | Subject, category(ies) |
| First subjects in a category | The first CR that create a category receive an |
| | enhanced score |
| Home platform analytics | Reports, metrics, stats, customizations, |
| | subject, category(ies) |
| Complementary Category | Related categories, subject, match repeti- |
| Matches | tions, match coincidence and priority, key |
| | word matching accuracy, and key word |
| | matching repetition |
| User compatibility match | Points added for: |
| | Suggested users, user selected from match, |
| | match created, subject/users, categories, |
| | positive astrological aspects, users CR |
| | matches, users interaction matches, custom- |
| | ized user interests, customized users ranked |
| | search priorities, et al. Points subtracted |
| | for: Negative astrological aspects, et al. |

Table 2 shows a list of external interactions that may have score points associated with them, and items (or entities) that may receive score points upon the occurrence of the interactions. The interactions and scored items shown in Table 1 are examples and are not intended to be an exhaustive list. It is noted that other implementations may feature different interactions and scored items.

TABLE 2

| INTERACTION | |
|---|---|
| (EXTERNAL) | ENTITY RECEIVING SCORE POINTS |
| External transactions without | Subject, category(ies), product/service, |
| a CR | producer, distributor, vendor, |
| | intermediary |
| Stock market transactions | Shares purchased, subject, category(ies), |
| | owning company, broker, affected market |
| | price, affected by time and volume |
| Analytics from other | Reports, statistics, metrics, subjects, |
| platforms | category(ies) |
| Ratings from other platforms | Ratings, averages, subjects, category(ies) |
| Search results from other | Algorithm, search results, rankings, |
| platforms | subjects, category(ies) |

It is noted that Table 1 and Table 2 show a limited number of interactions and scoring permutations that may be implemented. Alternate implementations may use a different set of scored user interactions and/or different entities that receive score for any given user interaction.

Furthermore, external events that are not necessarily user interactions may also be scored. Such external events would be stored as previously described, but would key off of something other than a user interaction. Examples of external events that may affect a score can include external transactions (where a transaction such as a purchase, may be detected and used as a trigger to adjust one or more scores), market movement (that may affect a score associated with a tracked stock or equity share), ratings from other platforms (that may be imported to adjust a score of an item), and the like.

### Example Item Score Database

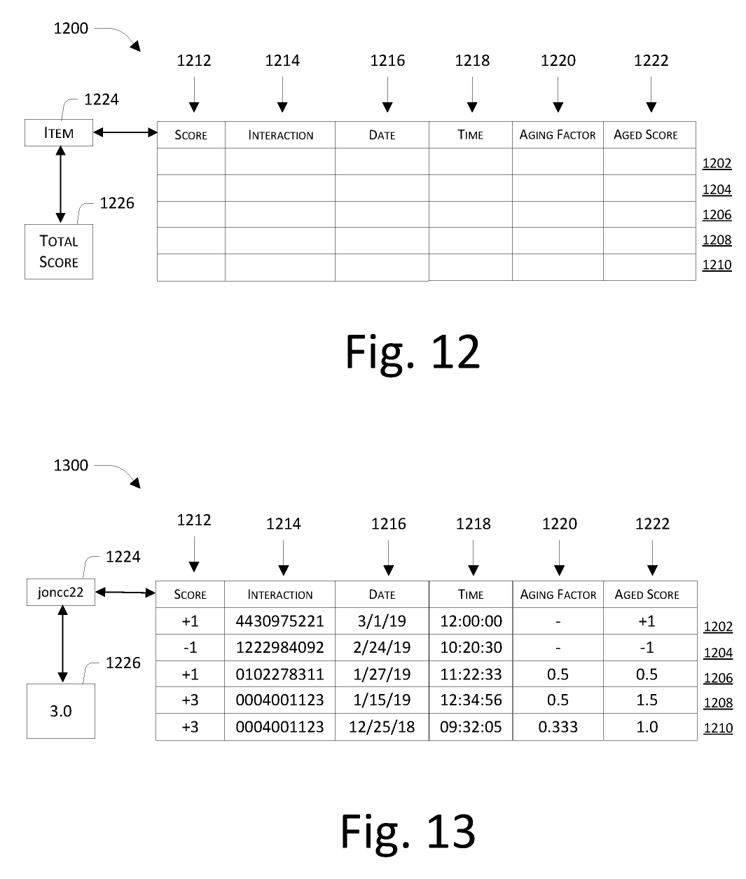

FIG. 12 depicts a representation of an example item score database 1200 that may be utilized with the techniques described herein. In the following discussion of the example item score database 1200, continuing reference is made to elements shown in and described with respect to previous figures. It is noted that the example item score database 1200 is only one particular implementation of a database that may be used to store information entered in content referrals. Those skilled in the art will recognize that similar databases or other storage, lookup, and recall techniques may be used with or in place of the example item score database 1200.

The item score database 1200 maintains a store of any entity that has a score associated with it in the system. Entities include, but are not limited to, content referrals, users, lists, products, web sites, merchants, product distributors, events, restaurants, geographic locations, and the like. The master score database 1200 includes multiple records 1202-1210. Each record includes: an score field 1212, an interaction field 1214, a date field 1216, a time field 1218, an aging factor field 1220, and an aged score field 1222. The score field stores a base score value that is associated with an interaction identified in the interaction field 1214. The date field 1216 and the time field 1218 store a date and time, respectively, of the interaction identified in the interaction field 1214. The aging factor field 1220 contains a value that may be used to age scores. Not all scores will have age factors, but to keep scores current, some interactions may need to count for less as time goes on. For example, a score associated with a restaurant may have great reviews from 2012 to 2018, but not so good reviews after 2018. Since restaurant reviews are an indicator of quality at a specific point in time, aggregating scores associated with the reviews would give an inaccurate view of the current state of the restaurant. Therefore, it is desirable in some instances to give less weight to older reviews or other types of interactions. The aged score field 1222 contains the result of applying the aging 1220 factor to the score 1212.

The example item database 1200 is associated with an item 1224, or entity (person, place, thing, etc.) and a total score 1226 is associated with the item 1224. The total score 1226 is an aggregation of values in the aged score field 1222 in all records associated with the item 1224. The total score value 1226 is updated at regular intervals and/or upon the occurrence of certain events. As such, a total score value 1226 for every scored item 1224 is available for use in rankings and searches.

FIG. 13 depicts an example score database 1300 that is similar to the example item score database 1200 shown in and described with respect to FIG. 12, but with example values included to demonstrate how it is used. The item 1224 identifies a person associated with the example score database 1300, namely, “joncc22.” Records 1202-1210 identify interactions involving joncc22, each of the interactions having a score associated therewith. Some of the interactions have an aging factor associated therewith. For example, the interaction denoted by record 1206 has a score of +1 that is multiplied by an aging factor of 0.5 to derive an aged score value of 0.5. Similarly, the interaction denoted by record 1210 has a score of +3 that is multiplied by an aging factor of 0.333 to derive an aged score value of 1.0. The total score value 1226 for joncc22 is derived by summing the aged scores from each record. In this abbreviated example, the total score value 1226 for joncc22 is 3.0.

### Example System—Electronic Device

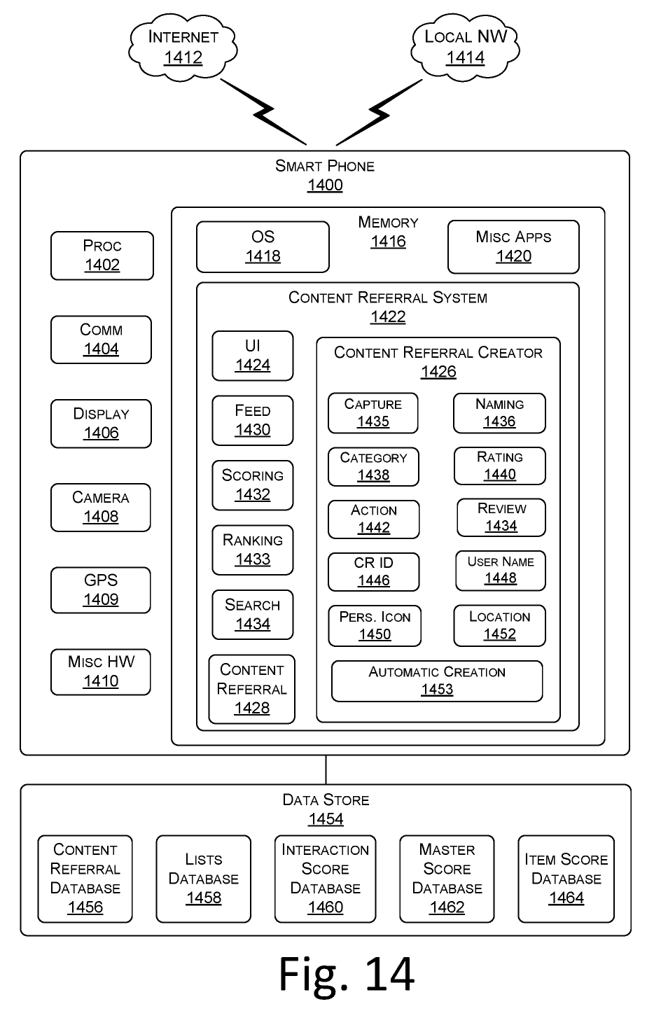

FIG. 14 is a block diagram representing an example electronic device on which one or more portions of the present inventions may be implemented. In this particular example, the example electronic device is a smart phone 1400, but similar techniques would be employed on any other suitable type of electronic device, such as a tablet or a computer.

In the following discussion, particular names have been assigned to individual components of the example smart phone 1400. It is noted that a name of an element is exemplary only, and that a name is not meant to limit a scope or function of an associated element. Furthermore, certain interactions may be attributed to particular components. It is noted that in at least one alternative implementation not particularly described herein, other component interactions and communications may be provided. The following discussion of FIG. 14 merely represents a subset of all possible implementations. Furthermore, although other implementations may differ, one or more elements of the example smart phone 1400 are described as a software application that includes, and has components that include, code segments of processor-executable instructions. As such, certain properties attributed to a particular component in the present description, may be performed by one or more other components in an alternate implementation. An alternate attribution of properties, or functions, within the example smart phone 1400 is not intended to limit the scope of the techniques described herein or the claims appended hereto.

The example smart phone 1400 includes one or more processors 1402, one or more communication interfaces 1404, a display 1406, a camera 1408, and miscellaneous hardware 1410. Each of the one or more processors 1402 may be a single-core processor or a multi-core processor. The communication interface(s) 1404 facilitates communication with components located outside the example smart phone 1400, and provides networking capabilities for the example smart phone 1400. For example, the example smart phone 1400, by way of the communications interface 1404, may exchange data with other electronic devices (e.g., laptops, computers, other servers, etc.) via one or more networks, such as the Internet 1412 or a local network 1414. Communications between the example smart phone 1400 and other electronic devices may utilize any sort of communication protocol known in the art for sending and receiving data and/or voice communications.

The display 1406 is a typical smart phone display in the present example, but may be an external display used with a smart phone or other type of electronic device. The camera 1408 is shown integrated into the example smart phone 1400, but may be an external camera used with the example smart phone 1400 or a different type of electronic device. A Global Positioning System 1409 or some other type of location-determining component is included. The miscellaneous hardware 1410 includes hardware components and associated software and/or or firmware used to carry out device operations. Included in the miscellaneous hardware 1410 are one or more user interface hardware components not shown individually—such as a keyboard, a mouse, a display, a microphone, a camera, and/or the like—that support user interaction with the example smart phone 1400 or other type of electronic device.

The example smart phone 1400 also includes memory 1416 that stores data, executable instructions, modules, components, data structures, etc. The memory 1416 can be implemented using computer readable media. Computer-readable media includes at least two types of computer-readable media, namely computer storage media and communications media. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. Computer storage media may also be referred to as “non-transitory” media. Although, in theory, all storage media are transitory, the term “non-transitory” is used to contrast storage media from communication media, and refers to a component that can store computer-executable programs, applications, and instructions, for more than a few seconds. In contrast, communication media may embody computer readable instructions, data structures, program modules, or other data in a modulated data signal, such as a carrier wave, or other transmission mechanism. Communication media may also be referred to as “transitory” media, in which electronic data may only be stored for a brief amount of time, typically under one second.

An operating system 1418 is stored in the memory 1416 of the example smart phone 1400. The operating system 1418 controls functionality of the processor(s) 1402, the communications interface(2) 1404, the display 1406, the camera 1408, and the miscellaneous hardware 1410. Furthermore, the operating system 1418 includes components that enable the example smart phone 1400 to receive and transmit data via various inputs (e.g., user controls, network interfaces, and/or memory devices), as well as process data using the processor(s) 1402 to generate output. The operating system 1418 can include a presentation component that controls presentation of output (e.g., display the data on an electronic display, store the data in memory, transmit the data to another electronic device, etc.). Additionally, the operating system 1418 can include other components that perform various additional functions generally associated with a typical operating system. The memory 1416 also stores miscellaneous software applications 1420, or programs, that provide or support functionality for the example smart phone 1400, or provide a general or specialized device user function that may or may not be related to the example smart phone 1400 per se. The software applications 1420 include system software applications and executable applications that carry out non-system functions.

The memory 1416 also stores a content referral system 1422 that performs and/or controls operations to carry out the techniques presented herein and includes several components that work together to provide the improved systems, methods, etc., presently described. The content referral system 1422 includes a user interface 1424, a content referral creator 1426, and a content referral 1428. The user interface 1424 contains elements that support input and output communications between the example smart phone 1400 and a user thereof. The user interface 1424 also provides functionality for some user interface elements, such as functions represented by the widget icons 128 of FIG. 1 (i.e., functionality for attributes, like, recycle, comment, thanks, forward). The content referral creator 1426 supports functionality that allows a user to create a content referral (see FIG. 1) as described herein. The content referral 1428 is created by the content referral creator 1426. The content referral 1428, while not always present in the memory 1416, is shown to represent a content referral such as the example content referral (FIG. 1). Typically, the content referral 1428 includes the data stored in a record of the example content referral database 900 (FIG. 9). The content referral system 1422 also includes a feed 1430 that generates and stores a user feed similar to the feed 200 shown in and described with respect to FIG. 2. The content referral system 1422 also includes a scoring module 1432, a ranking module 1433, and a search module 1434.

The content referral creator 1426 includes functional elements that create the content referral 1428. The content referral creator 1426 includes a capture component 1435 that provides functionality to capture media content used in a content referral, be it a single image, multiple images, audio, etc. In the present example, the capture component 1435 is also configured to create an image icon 118 (FIG. 1) associated with the captured media content. The content creator 1426 also includes a naming component 1436, a category module 1438, a rating component 1440, an action component 1442, and a review component 1444. The naming component 1436 supports functionality to receive a subject name for a content referral. The category module 1438 is configured to support the functionality described with respect to identifying categories to be associated with the content referral. The rating component 1440 provides functionality to support the rating process previously described. The action component 1442 is configured to provide supporting functionality for associating one or more actions to be associated with the content referral. The review component 1444 provides the functionality for receiving and storing a review from the user.

The content referral creator 1426 also includes a content referral identifier module 1446, a user name 1448, a personal icon 1450, and a location 1452. The content referral identifier module 1446 creates and stores a content referral identifier that uniquely identifies an associated content referral. The user name 1448 is a user name associated with a user that creates a content referral, and will typically be an owner of the example smart phone 1400 or other electronic device. The personal icon 1450 is an icon chosen by a user to represent the user in the content referral system 1426, in content referrals, comments and ratings on other content referrals, and the like. The location 1452 is a value that identifies a location associated with a content referral being created, such as geographical coordinates obtained from the GPS 1409 when content associated with the content referral is captured.

The example smart phone 1400 communicates with a data store 1454 that stores a content referral database 1456 (similar to the example content referral database 900 shown in and described with respect to FIG. 9), a lists database 1458 (similar to the example lists database 1000 shown in and described with respect to FIG. 10), an interaction score database 1460 (similar to the interaction score database 1100 shown in and described with respect to FIG. 11), a master score database 1462 (similar to the master score database 1200 shown in and described with respect to FIG. 12), and an item score database 1464 (similar to the item score database 1300) database shown in and described with respect to FIG. 13. Although shown located external to the example smart phone 1400, at least some of the data stored in the data store may be located in the memory 1416 of the example smart phone 1400. Typically, however, the content referral system 1422 communicates with an external data store 1454 to have access to the full features of content referrals and supporting applications associated with the content referral system.

The content referral creator 1426 also includes an automatic creation component 1453. The automatic creation component 1453 is configured to automatically generate a content referral that includes several features described herein in relation to content referrals. The automatic creation module 1453 is configured to receive input that a certain activity has occurred, which triggers the automatic creation module 1453 to create a content referral. Other activities may trigger automatic creation of a content referral, such as detecting a non-online transaction (e.g. by scanning a code on a product receipt, etc.), accessing a streamed television show, and the like.

Those skilled in the art will appreciate that variances on the described implementation(s) may be implemented to take advantage of system characteristics and provide an efficient operating environment.

### Example Server

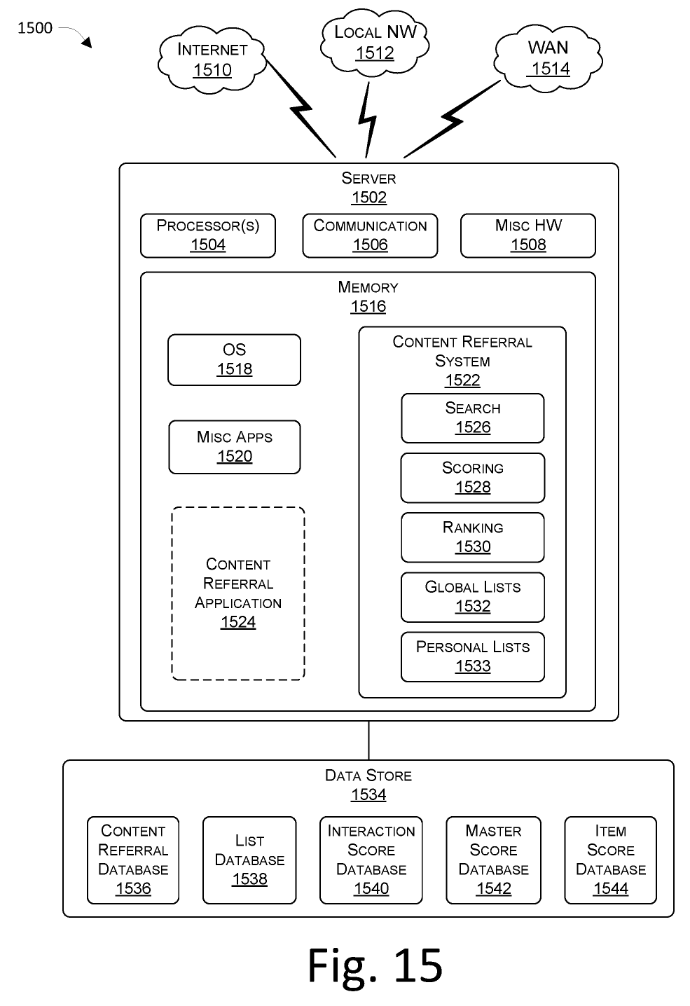

FIG. 15 is a block diagram depicting an example server operational environment 1500 in accordance with the techniques described herein. In the following discussion, particular names have been assigned to individual components of the example server operational environment 1500. It is noted that a name of an element is exemplary only, and that a name is not meant to limit a scope or function of an associated element. Furthermore, certain interactions may be attributed to particular components. It is noted that in at least one alternative implementation not particularly described herein, other component interactions and communications may be provided. The following discussion of FIG. 15 merely represents a subset of all possible implementations. Furthermore, although other implementations may differ, one or more elements of the example server operational environment 1500 are described as a software application that includes, and has components that include, code segments of processor-executable instructions. As such, certain properties attributed to a particular component in the present description, may be performed by one or more other components in an alternate implementation. An alternate attribution of properties, or functions, within the example server operational environment 1500 is not intended to limit the scope of the techniques described herein or the claims appended hereto.

The example server operational environment 1500 contains a server 1502 that includes one or more processors 1504, one or more communication interfaces 1506, and miscellaneous hardware 1508. Each of the one or more processors 1504 may be a single-core processor or a multi-core processor. The communication interface(s) 1506 facilitates communication with components located outside the server 1502, and provides networking capabilities for the server 1502. For example, the server 1502, by way of the communications interface(s) 1506, may exchange data with client electronic devices (e.g., laptops, computers, other servers, etc.) via one or more networks, such as the Internet 1510, a wide area network 1512, or a local network 1514. Communications between the example server 1502 and other electronic devices may utilize any sort of communication protocol known in the art for sending and receiving data and/or voice communications.

The miscellaneous hardware 1508 of the server 1502 includes hardware components and associated software and/or or firmware used to carry out server operations. Included in the miscellaneous hardware 1508 are one or more user interface hardware components not shown individually—such as a keyboard, a mouse, a display, a microphone, a camera, and/or the like—that support user interaction with the server 1502 or other type of electronic device.

The server 1502 also includes memory 1516 that stores data, executable instructions, modules, components, data structures, etc. The memory 1516 can be implemented using computer readable media as previously described, supra. An operating system 1518 is stored in the memory 1516 of the server 1502. The operating system 1518 controls functionality of the processor(s) 1504, the communications interface(s) 1506, miscellaneous hardware 1508. Furthermore, the operating system 1518 includes components that enable the server 1502 to receive and transmit data via various inputs (e.g., user controls, network interfaces, and/or memory devices), as well as process data using the processor(s) 1504 to generate output. The operating system 1518 can include a presentation component that controls presentation of output (e.g., display the data on an electronic display, store the data in memory, transmit the data to another electronic device, etc.). Additionally, the operating system 1518 can include other components that perform various additional functions generally associated with a typical operating system. The memory 1516 also stores miscellaneous software applications 1520, or programs, that provide or support functionality for the server 1502, or provide a general or specialized device user function that may or may not be related to the server 1502 per se. The software applications 1520 include system software applications and executable applications that carry out non-system functions.

The memory 1516 also stores a content referral system 1522 that performs and/or controls operations to carry out the techniques presented herein and includes several components that work together to provide the improved systems, methods, etc., presently described. In addition to supporting services available through the content referral system 1422 on the example smart phone 1400 shown in FIG. 14, the content referral system 1522 of the server 1502 also performs global operations that function across multiple users, such as creating global lists, global scoring, global ranking, etc.

It is noted that although the presently described implementations contemplate individual users executing a content referral system on a personal device, the server 1502 may include one or more instances of a client content referral system 1524. In such a system, the core functionality of the content referral system is executed primarily on the server 1502, and peripheral functionality, such as user input and output, content capture, etc., are performed on a user electronic device associated with an instance of a client content referral system.

The content referral system 1522 includes a search component 1526, a scoring component 1528, a ranking component 1530, a global lists component 1532 configured to manage global lists, and a personal lists component 1533 configured to manage personal lists. The search component 1526 is configured to receiving a search term from a client device and search an associated data store 1534 for relevant information. The data store 1534 shown in FIG. 15, can store many data items, such as user information, user feeds, user lists, global lists, product information, geographic information, business information, etc. The data stored is shown storing a content referral database 1536 (similar to the example content referral database 900 shown in and described with respect to FIG. 9), a list database 1538 (similar to the example list database 1000 shown in and described with respect to FIG. 10), an interaction score database 1540 (similar to the interaction score database 1100 shown in and described with respect to FIG. 11), a master score database 1542 (similar to the master score database 1200 shown in and described with respect to FIG. 12), an item score database 1544 (similar to the item score database 1300 shown in and described with respect to FIG. 13), The data store 1534 may be stored in the memory 1516 of the server 1502 or it may be stored in an external location that is accessible by the server 1502. The scoring component 1528 tracks activity associated with a subject of a content referral and adds or subtracts points based on various user input with respect to the content referral.

For example, the scoring component 1528 may track a user's actions when the user is creating a content referral, such as increasing a score when a user enters a higher rating and decreasing the score when the user enters a lower rating. Other factors, such as a positive review from a creator may be used in this regard. The scoring component 1528 may also track external factors to derive a score. For example, if a subject of a content referral is a company, the scoring component 1528 may track news about the company, a stock price of company stock, and similar things related to transactions and interaction done with respect to the company to increase or decrease the score associated with the company. The scoring component 1528 may also track actions by other users with regard to a content referral to derive a score for a subject of the content referral. In such a context, a score for a product that is the subject of a content referral may increase when a user actuates a “like” icon associated with the content referral, and may decrease if a negative reaction from a user is detected (by way of a negative comment, a lower rating, etc.). Virtually any indicator of a person's sentiment regarding a subject of a content referral may be used to derive a score associated with the subject.

The ranking component 1530 is configured to rank different items within a category to order the items according to a score calculated by the scoring component 1528. For example, if there is a category of restaurants, the ranking component will determine the ranked order of all content referrals related to an item associated with the restaurant category. Such ranking may be limited to a maximum number of items, such as ten (10), forty (40), or any other practicable number. The ranked order of items in a category are stored as lists in the global lists 1532. The lists are global lists because they are lists that take into account content referrals created by multiple users in the system, whereas personal lists are rankings of one user's items in a category.

### Example Methodological Implementation—Updating Scores

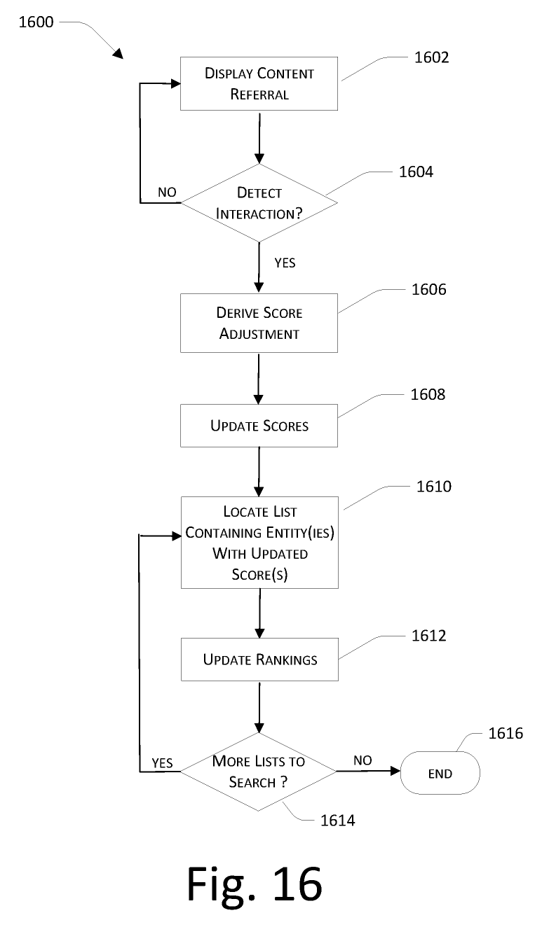

FIG. 16 is a flow diagram 1600 that depicts an example methodological implementation for ranking for use in the techniques presented herein. In the example under discussion below, the operations identified in flow diagram blocks are performed by a content referral system or component thereof. In the following discussion of the flow diagram 1600, continuing reference may be made to the element names and/or reference numerals shown in previous figures. It is noted that although particular steps are described in the following discussion of the flow diagram 1600, more or fewer steps may be included in an alternative methodological implementation. Furthermore, two or more discrete steps shown in and described with respect to the flow diagram 1600 may be combined into a single step in a logical implementation of one or more of the techniques described herein.

At block 1602 a content referral (FIG. 1) is displayed on an electronic device 100. As long as there is no user interaction with the content referral, no update is initiated (“No” branch, block 1604). If a user interaction with the content referral is detected (“Yes” branch, block 1604), the a score adjustment is derived at block 1606. To derive a score adjustment, a content referral system (content referral system 1422, FIG. 14) determines what type of user interaction was detected. This may be accomplished by receiving a notice from a device operating system (operating system 1418, FIG. 14) or other component that identifies the type of interaction. A scoring module (scoring module 1432, FIG. 14) of the content referral system 1422 looks up the type of interaction in an interaction score database 1100 (FIG. 11). The scoring module 1432 then determines a score corresponding to the user interaction.

At block 1608, the scoring module 1432 updates one or more scores as a result of the user interaction. Scores that are updated are scores associated with an entity, such as a person, list, location, thing, distributor, corporation, etc. From the identity of the user interaction, the entities to be updated are found in the interaction score database. Scores found in the master score database that are associated with such entities are updated by the value of the score found in the interaction score database corresponding to the user interaction. The score may be increased or decreased depending on the value assigned to the identified user interaction. An updated score is then saved in the master score database.

At block 1610, a ranking module (ranking module 1433, FIG. 14) searches a list database (list database 1000, FIG. 10) to find a list that contains at least one of the entity names to be updated. When such a list is found, the ranking module re-ranks the list so as to take into account the updated score(s). If there are more lists to search (“Yes” branch, block 1614), then the process repeats from block 1610. When there are no more lists to be searched (“No” branch, block 1614), the process terminates at block 1616.

### Example Methodological Implementation—Search

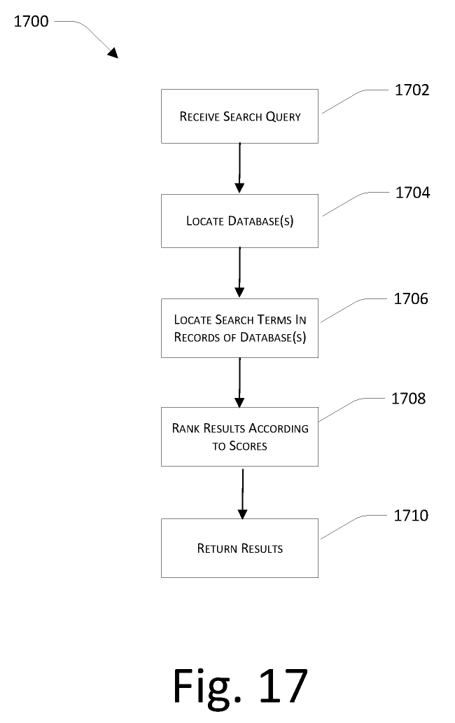

FIG. 17 is a flow diagram 1700 that depicts an example methodological implementation for search for use in the techniques presented herein. In the following discussion of the flow diagram 1700, continuing reference may be made to the element names and/or reference numerals shown in previous figures. It is noted that although particular steps are described in the following discussion of the flow diagram 1700, more or fewer steps may be included in an alternative methodological implementation. Furthermore, two or more discrete steps shown in and described with respect to the flow diagram 1700 may be combined into a single step in a logical implementation of one or more of the techniques described herein.

At block 1702, a search module (search module 1434, FIG. 14) receives a search query from a user. The search module 1434 locates an appropriate database to search at block 1704 and attempts to locate search terms in records of the database at block 1706. At block 1708, a ranking module (ranking module 1433, FIG. 14) ranks results according to scores. In techniques contemplated in the present description, search results will often comprise ranked lists of items and such lists have scores associated with them. When the search results contain several lists, the scores associated with the lists are compared, and the results are returned in order of score—usually in ascending order (from highest score to lowest score). Sometimes, the number of search results may be limited by, for example, the format of the display that will show the search results. If so, lists with scores below the list occupying the last available search result slot will be discarded. At block 1710, the search results are returned and displayed according to a selected format.

### CONCLUSION

Although the present disclosure has been described in detail, it should be understood that various changes, substitutions and alterations may be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A method, comprising:
identifying a content referral that includes an element and a favorability indication;
deriving a score adjustment for the element, a magnitude of the score adjustment being dependent on the favorability indication;
combining the score adjustment with a score that is associated with the element to derive an updated score that is associated with the element;
storing the updated score with the associated element in a database with multiple records;
receiving a search query to be executed on the database;
identifying information in the database records that satisfies the search query to derive search results;
ranking the search results, said ranking being according to, at least in part, updated scores;
returning the search results.

2. The method as recited in claim 1, wherein the element further comprises an item included in the content referral.

3. The method as recited in claim 1, wherein the element further comprises the content referral itself.

4. The method as recited in claim 1, wherein the element further comprises a category included in the content referral.

5. The method as recited in claim 1, wherein a search query containing the element as a search term returns one or more lists that contain the element.

6. The method as recited in claim 1, wherein a search query containing the element as a search term returns one or more individual content referrals related to the element.

7. The method as recited in claim 1, wherein the favorability indication is one or more of the following favorability indications: a rating of the element; a review of the element; an attribute assignment related to the element; a procurement of the element; an action taken with respect to the element, adding the element to a personal list.

8. The method as recited in claim 1, wherein the content referral is stored in one or more ranked lists, and a position of the content referral in a list is determined, at least in part, by an updated score associated with the element.

9. The method as recited in claim 1, wherein the element further comprises an indicator of an external occurrence.

10. The method as recited in claim 1, wherein the element further comprises an action selected by a user, the action initiating a process with an external entity.

11. The method as recited in claim 1, further comprising:
assigning a score adjustment to a creator of the content referral, a magnitude of the score adjustment being dependent on the favorability indication;
combining the score adjustment with a score that is associated with the creator to derive an updated score that is associated with the creator;
storing the updated score that is associated with the creator;
receiving a search query that includes the creator as a search term;
identifying content referrals associated with the creator as search results; and
ranking the search results according to updated scores associated with the identified content referrals.

12. The method as recited in claim 11, further comprising:
identifying that the content referral is a derivative of a content referral created by an original creator; and
updating a score associated with the original creator with the score adjustment or a variant thereof.

13. The method as recited in claim 1, wherein the score adjustment is based, at least in part, on public information related to the element.

14. The method as recited in claim 1, further comprising:
assigning a score adjustment to an entity associated with the element, a magnitude of the score adjustment being dependent on the favorability indication;
deriving an updated score by combining the score adjustment with a score associated with the entity; and
storing the updated score in association with the entity.

15. The method as recited in claim 14, wherein the entity is an entity of one of the following types of entities: an author of the element; a distributor of the element; a purchaser of the element; a performing artist associated with the element; a collaborator of an element; a voter in a poll element; a subject of an action taken with respect to the element.

16. One or more computer-readable storage media storing computer-executable instructions that, when executed, perform operations that include the following:
displaying a content referral, the content referral having multiple elements;
detecting a user interaction with an element of the content referral;
updating a score based on the user interaction;
ranking a list that contains an element affected by the updating step;
receiving a search query containing a search term;
searching content referrals for the search term; and
returning one or more content referrals that contain the search term.

17. The one or more computer-readable storage media as recited in claim 16, wherein the returning one or more content referrals that contain the search term further comprises returning a list that includes a content referral that contains the search term.

18. The method as recited in claim 17, wherein the returning a list further comprises returning a list having the greatest score when two or more lists are identified as including a content referral that contains the search term.

19. The one or more computer-readable storage media as recited in claim 16, wherein the content referral is in the process of being in a content referral user interface.

20. The one or more computer-readable storage media as recited in claim 16, wherein the updating a score based on the user interaction includes updating a score related to at least one of the following: the user; the content referral; the element of the content referral; an item related to a subject of the content referral; an entity associated with the subject of the content referral; a place associated with the subject of the content referral; a category associated with the subject of the content referral.

21. The one or more computer-readable storage media as recited in claim 16, wherein the ranking a list further comprises comparing a score for each item in the list and ranking the items in the list according to the scores.

22. The one or more computer-readable storage media as recited in claim 16, further comprising:
identifying a score associated with the detected user interaction; and
wherein the updating a score based on the user interaction further comprises combining the score based on the user interaction with an existing score.

23. The one or more computer-readable storage media as recited in claim 22, wherein the score associated with the detected user interaction can be a positive number, zero, or a negative number depending on whether the user interaction is positive, neutral, or negative, respectively.

24. The one or more computer-readable storage media as recited in claim 14, wherein:
the search term further comprises a characteristic of a person;
the returning one or more content referrals further comprises returning one or more content referrals matching the search term; and
a creator of the returned content referral is a person having the characteristic identified in the search term.

25. A system, comprising:
a processor;
memory;
a content referral stored in the memory, the content referral including actuatable components with which a user may interact, a subject element, and a category element;
a content referral system configured to cause the content referral to be displayed on a system device and to detect interactions between the user and the actuatable components;
a scoring component configured to assign scoring values to the interactions and to update scores associated with the subject element, the category element, or both the subject element and the category element;
a search component that receives one or more search terms related to the subject element or the category element and identifies content referrals that include the search terms;
a ranking component configured to rank the search results according to scores associated with elements in the search results; and
wherein the search component is configured to return the ranked search results.

26. The system as recited in claim 25, wherein the scoring values are based on actions taken by the user that indicates a level of favorability of the user with respect to the content referral or to the subject element.

27. The system as recited in claim 25, wherein the search results further comprise ranked lists in which the search terms are present.

28. The system as recited in claim 25, wherein the ranking component is further configured to rank content referrals in lists of content referrals according to scores associated with the content referrals.

29. The system as recited in claim 25, wherein the ranking component is further configured to rank subject elements in lists associated with the subject elements according to scores associated with the subject elements.
